(19) United States
(12) Patent Application Publication
(10) Pub. No.: US 2019/0263322 A1
(43) Pub. Date: Aug. 29, 2019

(54) MONITOR INNER MIRROR FOR VEHICLE

(71) Applicant: MURAKAMI CORPORATION, Shizuoka (JP)

(72) Inventors: Daiki HAYASHI, Yaizu-shi (JP); Akira FUKAI, Shimada-shi (JP); Fumitaka KITAGAWA, Yaizu-shi (JP)

(73) Assignee: MURAKAMI CORPORATION, Shizuoka (JP)

(21) Appl. No.: 16/333,848

(22) PCT Filed: Sep. 6, 2017
(86) PCT No.: PCT/JP2017/032112

§ 371 Date: Mar. 15, 2019

(30) Foreign Application Priority Data
Sep. 29, 2016 (JP) 2016-191979

(51) Int. Cl. B60R 1/12; G02F 1/1335; G02F 1/1339; G02F 1/1333; B60R 1/04; B60R 1/08

(52) U.S. Cl. CPC B60R 1/12; G02F 1/133536; G02F 1/1339; G02F 1/133308; B60R 2001/1215; B60R 1/08; G02F 2001/133567; G02F 2001/133331; B60R 1/04

(57) ABSTRACT

A monitor inner minor for a vehicle includes a liquid-crystal shutter and a display device disposed behind the liquid-crystal shutter. The liquid-crystal shutter is switched between a mirror state and a transmissive state by electrical driving. An entire front shape of the monitor inner mirror for a vehicle is a horizontally-long shape. A power supply section that supplies a drive voltage to the liquid-crystal shutter is disposed at one short side of left and right short sides of the liquid-crystal shutter. Liquid-crystal encapsulation section is disposed on the other short side of the left and right short sides of the liquid-crystal shutter. The liquid-crystal encapsulation section is formed by sealing an injection port used for injecting liquid crystal to the liquid-crystal shutter with a seal material.

### TECHNICAL FIELD

This invention relates to a monitor inner mirror for a vehicle, that is switchable between a mirror state and a monitor image display state and allows a good design.

### BACKGROUND ART

A monitor inner mirror is an inner mirror with an image display device incorporated therein and is also called, e.g., a room mirror monitor. As a monitor inner mirror that is switchable between a mirror state and a monitor image display state, there is one described in Patent Literature 1. This monitor inner mirror includes a liquid-crystal shutter formed by disposing a reflection type polarizer on the back of a liquid-crystal cell and an image display device using a liquid-crystal monitor, the image display device being disposed on a partial region of the back of the liquid-crystal shutter.

### CITATION LIST

### Patent Literature

Patent Literature 1: Japanese Patent No. 4418483

### SUMMARY OF INVENTION

### Technical Problem

The liquid-crystal cell of the liquid-crystal shutter includes a power supply section and a liquid-crystal encapsulation section (liquid-crystal sealing section) at a peripheral edge thereof. The power supply section is a part including a terminal that supplies a drive voltage to the liquid-crystal shutter. The liquid-crystal encapsulation section is a part that seals an injection port used for injecting liquid crystal into the liquid-crystal shutter, with a seal material. The power supply section and the liquid-crystal encapsulation section need to be covered by a cover such as a bezel from the perspective of design as the monitor inner mirror is viewed from the front. However, depending on the disposition of the power supply section and the liquid-crystal encapsulation section, a width of the cover such as a bezel (width of an edging) becomes larger, causing deterioration of design by the cover.

This invention provides a monitor inner mirror for a vehicle allowing a good design.

### Solution to Problem

A monitor inner mirror for a vehicle according to this invention is a monitor inner mirror for a vehicle, including a liquid-crystal shutter that can be switched between a mirror state and a transmissive state by electrical driving and a display device disposed behind the liquid-crystal shutter, an entire front shape of the monitor inner mirror being a horizontally-long shape, wherein a power supply section that supplies a drive voltage to the liquid-crystal shutter is disposed at one short side of left and right short sides of the liquid-crystal shutter and a liquid-crystal encapsulation section including an injection port used for injecting liquid crystal to the liquid-crystal shutter, the injection port being sealed by a seal material, is disposed at another short side of the left and right short sides. In a monitor inner mirror, it is necessary to visually cover the power supply section and the liquid-crystal encapsulation section of the liquid-crystal shutter using a cover such as a bezel from the perspective of design as the monitor inner mirror is viewed from the front. In this case, if the power supply section and/or the liquid-crystal encapsulation section are disposed at an upper or lower long side of the liquid-crystal shutter, a width of the cover becomes wide at the long side, resulting in a poor design. According to this invention, the power supply section and the liquid-crystal encapsulation section are disposed at the left and right short sides of the liquid-crystal shutter, enabling reduction of the width of the cover at the long side or elimination of the cover at the long side and thus allowing a good design. Also, the power supply section and the liquid-crystal encapsulation section are disposed so as to be separated to the left and right short sides, allowing easy provision of a design in which the front shape of the monitor inner mirror is bilaterally symmetrical by making widths of covers for the left and right short sides equal to each other and thus allowing a good design. Note that the monitor inner mirror for a vehicle according to the present invention is not limited to one disposed at an upper front part of a vehicle but may be one disposed at any position inside a vehicle.

The monitor inner mirror for a vehicle according to this invention can includes: a body with the liquid-crystal shutter and the display device disposed at a front thereof; and a cover that visually covers the power supply section and the liquid-crystal encapsulation section of the liquid-crystal shutter as viewed from the front of the body, the cover being attached to the body. Accordingly, the power supply section and the liquid-crystal encapsulation section can visually be covered by the cover attached to the body.

In the monitor inner mirror for a vehicle according to this invention, it is possible that the cover is, for example, one that visually covers each of the entire left and right short sides of the liquid-crystal shutter. Accordingly, the cover can visually cover the entire left and right short sides of the liquid-crystal shutter, the short sides including the power supply section and the liquid-crystal encapsulation section.

In the monitor inner mirror for a vehicle according to this invention, it is possible that the cover is separated to a left part and a right part that are attached to left and right side parts of the body, respectively. Accordingly, covers can be attached to the left and right side parts of the body, separately.

In the monitor inner mirror for a vehicle according to this invention, it is possible that upper and lower long sides of the liquid-crystal shutter are exposed at the front of the body. Accordingly, there are no covers that cover the upper and lower long sides of the liquid-crystal shutter, enabling reduction of the widths of the covers at the long sides or elimination of the covers at the long sides and thus enabling provision of a monitor inner mirror with a good design.

In the monitor inner mirror for a vehicle according to this invention, it is possible that: the liquid-crystal shutter is mounted to a front of the display device; and the display device is mounted to the body by fastening a back of the display device to the body via a screw. If a design in which the liquid-crystal shutter and the display device are screw-fastened to the body by inserting a screw from the front side of the liquid-crystal shutter and the display device is employed, it is necessary to form a screw-fastening region extending outward at outer peripheries of the liquid-crystal shutter and the display device to screw-fasten the liquid-crystal shutter and the display device to the body at the screw-fastening region. However, such configuration needs a structure in which the screw-fastening region is hidden from the front side, resulting in deterioration in design. On the other hand, the need for the extension region is eliminated by screw-fastening the liquid-crystal shutter and the display device from the back side within respective surfaces thereof, resulting in enhancement in design.

In the monitor inner mirror for a vehicle according to this invention, it is possible that the cover visually covers a head of the screw on a rear side of the body. Accordingly, a favorable design can be ensured by visually covering the head of the screw for screw-fastening the display device to the body, using the cover.

In the monitor inner mirror for a vehicle according to this invention, it is possible that the cover clamps left and right side parts of the body from the front side and the rear side of the body and is thereby attached to the left and right side parts of the body. Accordingly, the cover can easily be attached. Also, employment of a design in which parts of the cover, the parts being disposed on the front side of the left and right side parts of the body, are disposed on the front side of the left and right short sides of the liquid-crystal shutter enables the parts to have a function that prevents the liquid-crystal shutter from coming off from the body.

### BRIEF DESCRIPTION OF DRAWINGS

FIG. 1 is an arrow X-X sectional view of the monitor inner mirror in FIG. 2A.

FIG. 2A is a front view illustrating an embodiment of a monitor inner mirror according to this invention.

FIG. 2B is a back view of the monitor inner mirror in FIG. 2A.

FIG. 2C is a right side view of the monitor inner mirror in FIG. 2A.

FIG. 3A is a front view illustrating a body of the monitor inner mirror in FIG. 2 with a display device disposed in a front recess thereof.

FIG. 3B is a back view of the body in FIG. 3A.

FIG. 3C is a right side view of the body in FIG. 3A.

FIG. 4A is a front view of a right cover of the monitor inner mirror in FIG. 2.

FIG. 4B is a back view of the right cover in FIG. 4A.

FIG. 5A is a diagram illustrating a method of attaching left and right covers to the body in FIG. 3, which is a perspective diagram of the body and the left and right covers as viewed obliquely from the upper front side.

FIG. 5B is a perspective diagram of the state in FIG. 5A as viewed obliquely from the upper back side.

FIG. 6 is an arrow Y-Y sectional view of the monitor inner mirror in FIG. 2A.

FIG. 7 is a schematic sectional view of the monitor inner mirror body in FIG. 1.

FIG. 8 is a front view of the liquid-crystal shutter in FIG. 1.

FIG. 9 is a schematic diagram illustrating a left side of the liquid-crystal shutter in FIG. 1 with a front-side glass substrate removed, which illustrates an example of a structure of a power supply channel.

FIG. 10 is a schematic diagram illustrating an arrow I-I sectional in FIG. 9, which illustrates both glass substrates bonded together by a seal material.

FIG. 11 is an enlarged view of part A in FIG. 1, which illustrates a structure around a power supply section.

FIG. 12 is an enlarged view of part B in FIG. 1, which illustrates a structure around a liquid-crystal encapsulation section.

FIG. 13 is a schematic sectional view of the monitor inner mirror body at the position indicated by arrows Z-Z in FIG. 1, which illustrates an installation structure of a boss.

FIG. 14A is a front view illustrating another example of a front shape of the liquid-crystal shutter.

FIG. 14B is a front view illustrating still another example of the front shape of the liquid-crystal shutter.

### DESCRIPTION OF EMBODIMENT

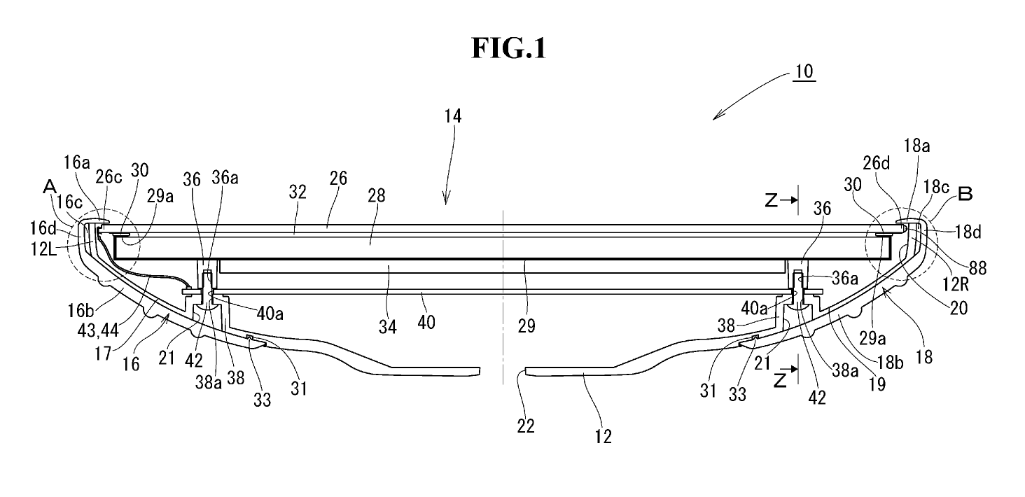

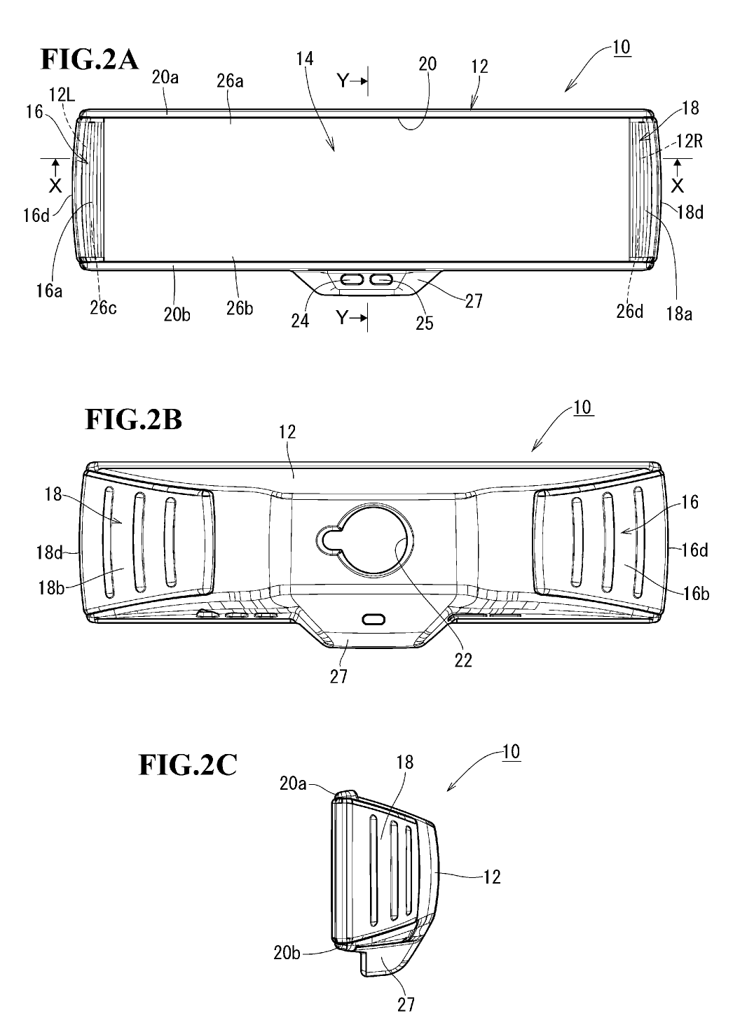

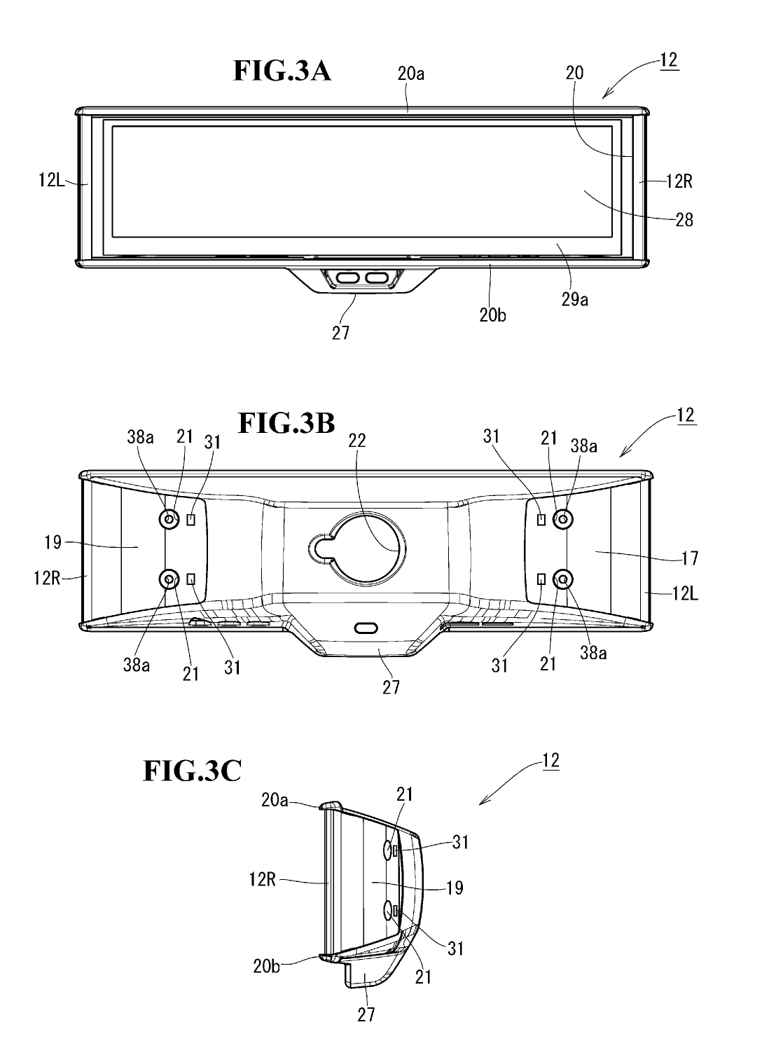

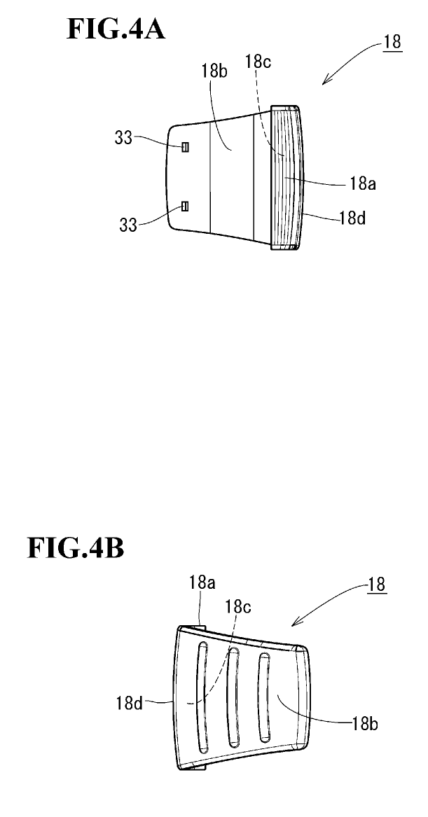

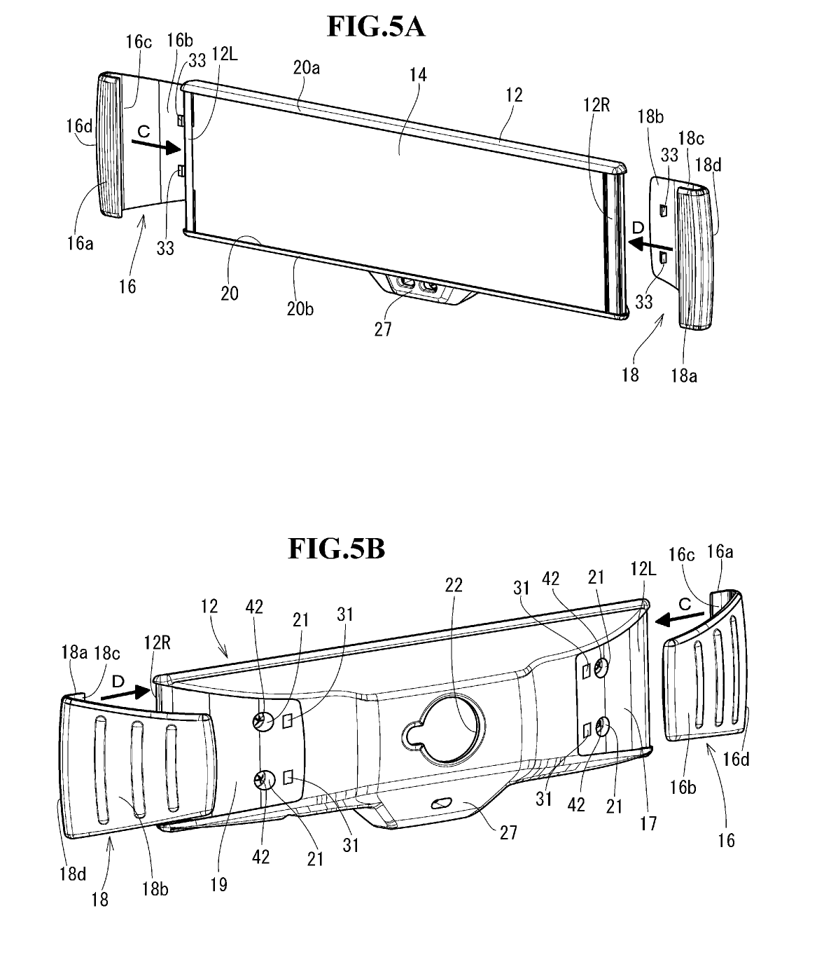

An embodiment of this invention will be described. FIG. 2 illustrates an embodiment of a monitor inner mirror according to this invention. FIG. 2A is a front view, FIG. 2B is a back view and FIG. 2C is a right side view. A monitor inner mirror 10 includes a body 12, a monitor inner mirror body 14 and left and right covers 16, 18. Each of the body 12 and the left and right covers 16, 18 is formed of an integrated molding of a resin. As illustrated in FIG. 2A, a front shape of the monitor inner mirror 10 is bilaterally symmetrical with respective to a central axis in a lateral direction. Each of respective entire front shapes of the monitor inner mirror 10 and the monitor inner mirror body 14 are formed in a horizontally-long quadrangular shape (horizontally-long rectangular shape). A front recess 20 in which the monitor inner mirror body 14 is to be received and disposed is formed in a front of the body 12. A front shape of the front recess 20 is a horizontally-long rectangular shape. The monitor inner mirror body 14 is screw-fastened and fixed to the body 12 via screws 42 (FIGS. 1 and 5B) inserted from the back side of the body 12, with the monitor inner mirror body 14 received and disposed in the front recess 20. The covers 16, 18 are fitted and attached to left and right side parts 12L, 12R of the body 12, respectively. In order to prevent the covers 16, 18 fitted and attached to the left and right side parts 12L, 12R of the body 12 from easily coming off from the left and right side parts 12L, 12R of the body 12, respective structures for locking such as claw engagement are formed between the covers 16, 18 and the left and right side parts 12L, 12R of the body 12. In other words, a claw fitting hole 31 is formed in each of upper and lower parts of each of respective surfaces of back recesses 17, 19 (FIG. 3B) of the left and right side parts 12L, 12R of the body 12. Also, a claw 33 is formed in a projecting manner at a position, at which the claw 33 faces a corresponding claw fitting hole 31, in each of retainer plates 16b, 18b (FIG. 4A) of the left and right covers 16, 18. Upon the covers 16, 18 being fitted and attached on the left and right side parts 12L, 12R of the body 12, the respective claws 33 are fitted in the corresponding claw fitting holes 31, and the covers 16, 18 are thus prevented from easily coming off from the body 12. A stay (not illustrated) for mounting the monitor inner mirror 10 is mounted in a hanging manner at a position close to a center position in a horizontal direction of an upper part of the front side of a vehicle cabin. An insertion hole 22 is formed in a back surface of the body 12. The insertion hole 22 is provided to mount the monitor inner mirror 10 to the stay in an angle-adjustable manner by a lower end of the stay being inserted to the insertion hole 22. An optical sensor 24 and an LED 25 are disposed in a bulge 27 at a center position in a horizontal direction of a front lower part of the body 12. The optical sensor 24 is used for an automatic antiglare function. The LED 25 indicates an on/off state of a monitor power supply.

FIG. 3 illustrates a structure of the body 12. FIG. 3A is a front view, FIG. 3B is a back view and FIG. 3C is a right side view. FIG. 3A illustrates a state in which the monitor inner mirror body 14 is disposed in the front recess 20 of the body 12. As illustrated in FIG. 3B, back recesses 17, 19 to which the covers 16, 18 are to be fitted and attached, respectively, are formed in left and right parts of a back of the body 12. Depressions 21 are formed at each of two positions in each of the upper and lower parts (four positions in total of the left and right back recesses 17, 19) of the respective surfaces of the back recesses 17, 19. The depressions 21 are provided to allow entrance of the screws 42 (FIGS. 1 and 5B) for screw-fastening the monitor inner mirror body 14 to the body 12. A screw through hole 38a is formed at a bottom of each depression 21.

FIG. 4 illustrates a structure of the right cover 18. FIG. 4A is a front view and FIG. 4B is a back view. The right cover 18 has a hook-like horizontal cross-sectional shape (see FIG. 1). The right cover 18 includes a bezel 18a on the front side, a retainer plate 18b on the back side and a flexure 18d between the bezel 18a and the retainer plate 18b, integrally. A recess 18c provided by the hook-like horizontal cross-sectional shape of the right cover 18 is formed on the inner side of the right cover 18. The flexure 18d is formed so as to have a thickness that is smaller than that of the retainer plate 18b for easy elastic deformation (see FIG. 1). The bezel 18a is formed so as to have a thickness that is equal to that of the flexure 18d and is tapered (that is, the thickness decreases toward a distal end). The left cover 16 has a structure that is bilaterally symmetrical to the right cover 18. To be more exact, the left cover 16 and the right cover 18 are components having a same structure, and the components of the same structure are used separately for the left cover 16 and the right cover 18 by rotating the components 180 degrees relative to each other in a planar direction. Note that the left cover 16 and the right cover 18 do not necessarily need to have a same structure and can have individual structures (that is, structures that are different from each other).

A rough procedure for assembling the monitor inner mirror 10 in FIG. 2 is as follows. A liquid-crystal shutter 26 and a display device 28 (FIG. 1) are assembled to each other in advance to form a monitor inner mirror body 14. The monitor inner mirror body 14 is put in the front recess 20 of the body 12, four screws 42 (FIGS. 1 and 5B) are inserted from the back side of the body 12 to fix the monitor inner mirror body 14 to the body 12. In this state, the covers 16, 18 are fitted and attached to the left and right side parts 12L, 12R of the body 12, respectively. The assembly is thus completed. FIG. 5 illustrates a method of mounting the left and right covers 16, 18 to the body 12. FIG. 5A is a diagram of the body 12 and the left and right covers 16, 18 as viewed obliquely from the upper front side, and FIG. 5B is a diagram of the body 12 and the left and right covers 16, 18 as viewed obliquely from the upper back side. After attachment of the monitor inner mirror body 14 to the body 12 via the screws 42, the left cover 16 is brought close to the left side part 12L of the body 12 laterally as indicated by arrow C. Then, the left side part 12L of the body 12 is made to enter a recess 16c of the left cover 16 and is fitted in the recess 16c while the flexure 16d being made to deform by the left side part 12L of the body 12. Consequently, the left cover 16 clamps the left side part 12L of the body 12 by means of an elastic force of the left cover 16 in a thickness direction of the body 12. In this way, the left cover 16 is attached to the left side part 12L of the body 12. At this time, the retainer plate 16b of the left cover 16 is held stably in the back recess 17 of the body 12. Heads of screws 42 exposed inside the back recess 17 are covered by the left cover 16. Likewise, the right cover 18 is also attached to the right side part 12R of the body 12. In other words, the right cover 18 is brought close to the right side part 12R of the body 12 laterally as indicated by arrow D. Then, the right side part 12R of the body 12 is made to enter the recess 18c of the right cover 18 and is fitted in the recess 18c while the flexure 18d being made to deform by the right side part 12R of the body 12. Consequently, the right cover 18 clamps the right side part 12R of the body 12 in the thickness direction of the body 12 by means of an elastic force of the right cover 18. In this way, the right cover 18 is attached to the right side part 12R of the body 12. At this time, the retainer plate 18b of the right cover 18 is held stably in the back recess 19 of the body 12. Heads of screws 42 exposed inside the back recess 19 are covered by the right cover 18.

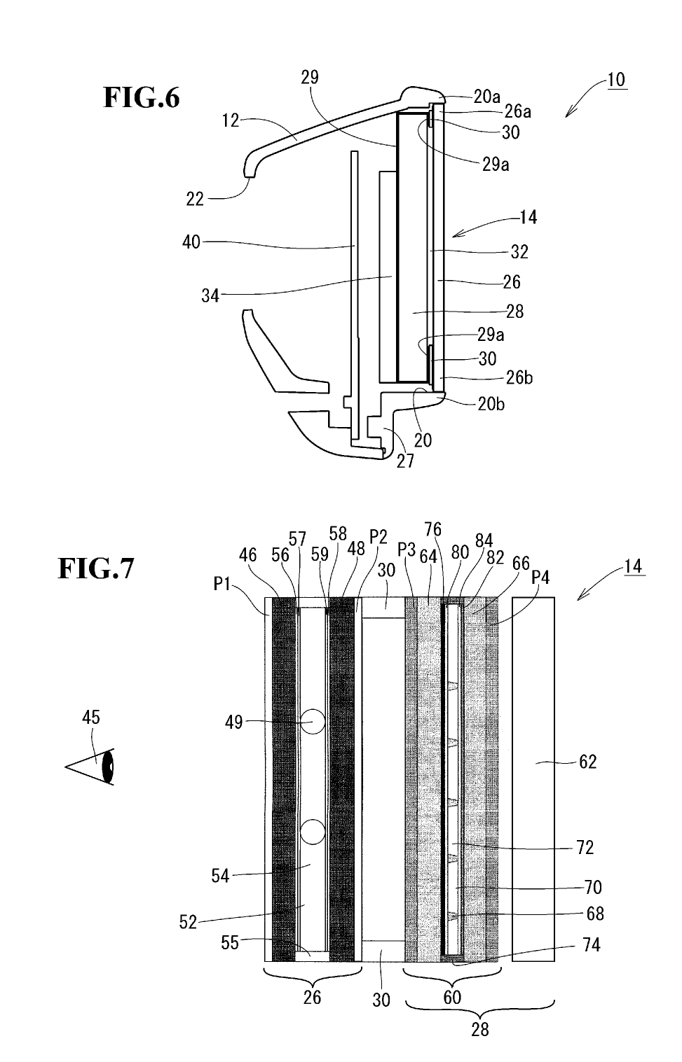

A cross-sectional structure of the monitor inner mirror 10 assembled as above will be described. FIGS. 1 and 6 illustrate an arrow X-X section of the monitor inner mirror 10 in FIG. 2A and an arrow Y-Y section of the monitor inner mirror 10 in FIG. 2A, respectively. The monitor inner mirror body 14 includes the liquid-crystal shutter 26 and the display device 28 disposed behind the liquid-crystal shutter 26. The liquid-crystal shutter 26 and the display device 28 are put together and bonded to each other with, e.g., a double-sided tape 30 (a double-sided stick tape or a double-sided adhesive tape), a bond or an adhesive around the entire outer peripheries of the liquid-crystal shutter 26 and the display device 28. The liquid-crystal shutter 26 and the display device 28 are joined and assembled to each other as described above to form the monitor inner mirror body 14. The monitor inner mirror body 14 is put in the front recess 20 of the body 12 and fixed to the body 12 by inserting four screws 42 (FIGS. 1 and 5B) from the back side of the body 12. As illustrated in FIGS. 1 and 6, an air layer 32 is formed between the liquid-crystal shutter 26 and the display device 28; however, it is possible to provide no air layer 32 by bringing the liquid-crystal shutter 26 and the display device 28 into close contact with each other. The liquid-crystal shutter 26 is formed so as to have an area that is somewhat larger than that of the display device 28 and the entire outer periphery of the display device 28 is disposed on the inner periphery side relative to the liquid-crystal shutter 26. The liquid-crystal shutter 26 is switched between a mirror state and a transmissive state by electrical driving. The display device 28 is formed of a light-emitting display device such as a monitor LCD. As what is called an electronic mirror, the display device 28 displays, e.g., an image of an area behind the vehicle taken by a rear camera disposed at the rear of the vehicle so as to face rearward of the vehicle, an image of an area obliquely behind a lateral side of the vehicle taken by a door camera disposed in a door mirror so as to face obliquely rearward of the lateral side of the vehicle or an image of an area obliquely below and behind the vehicle taken by a lower rear camera disposed at the rear of the vehicle so as to face obliquely downward and rearward of the vehicle. The monitor inner mirror body 14 is switched between the mirror state and the monitor image display state by a manual operation performed by a driver or automatic control based on a driving situation. Also, the mirror state is changed from/to a high reflectivity state to/from a low reflectivity state (antiglare state) by a manual operation performed by a driver or automatic control based on a driving situation.

In FIGS. 1 and 6, a back cover 29 made of a metal (for example, iron) is put on and attached to the display device 28 from the back side thereof. The back cover 29 covers an entire back surface, entire side surfaces and entire front peripheral edges of the display device 28. The double-sided tape 30 is attached to a bezel 29a (see FIG. 3A) at entire peripheral edges of the back cover 29 (surface of the bezel 29a). A circuit board 34 for the display device 28 is attached within the back surface of the display device 28. Within the back surface of the display device 28, a boss 36 is disposed in a projecting manner at each of four, upper and lower left and right, positions outside an area to which the circuit board 34 is attached. A female thread 36a is formed in each boss 36. In an inner peripheral surface of the body 12, bosses 38 are formed so as to project at four, upper and lower left and right, positions, so as to correspond to the four bosses 36. A screw through hole 38a is formed in each boss 38. A circuit board 40 is inserted between the bosses 36 and the bosses 38 of the four sets and the bosses 36 and the bosses 38 of the four sets are made to butt to each other. Then, four screws 42 are inserted from the back side of the body 12 to the respective female threads 36a through the screw through holes 38a and screw through holes 40a of the circuit board 40. Consequently, the monitor inner mirror body 14 and the circuit board 40 are mounted to the body 12 in a state in which the monitor inner mirror body 14 and the circuit board 40 are received in the front recess 20 of the body 12. The circuit board 40 is a circuit board that performs power supply to and control of the liquid-crystal shutter 26 and the display device 28. Harnesses 43, 44 (electric wires) that perform power supply from the circuit board 40 to the liquid-crystal shutter 26 are connected between the circuit board 40 and the liquid-crystal shutter 26. If the monitor inner mirror body 14 is screw-fastened to the body 12 from the front side of the monitor inner mirror 10, it is necessary to form screw-fastening regions extending outward at an outer periphery of the monitor inner mirror body 14. In this case, covers that cover the screw-fastening regions are necessary for a front of the monitor inner mirror 10, resulting in deterioration in design. On the other hand, in this embodiment, screw-fastening regions (bosses 36) are formed within a surface on the back side of the monitor inner mirror body 14 and thus there is no need to form screw-fastening regions extending outward at the outer periphery of the monitor inner mirror body 14, resulting in enhancement in design.

FIG. 7 schematically illustrates a cross-sectional structure of the monitor inner mirror body 14. In FIG. 7, the left side of the monitor inner mirror body 14 is the front side of the monitor inner mirror body 14 and the right side of the monitor inner mirror body 14 is the back side of the same. A viewing point 45 of a viewer such as a driver is positioned on the front side of the monitor inner mirror body 14. The liquid-crystal shutter 26 has a structure in which a void 52 is formed by making two glass substrates 46, 48 face each other with spacers 49 interposed therebetween. TN liquid crystal 54 is encapsulated in the void 52. An entire outer periphery of the void 52 is sealed by a seal material 55 (adhesive). ITO transparent electrode films 56, 58 are formed on mutual inner surfaces (surfaces facing each other) of the glass substrates 46, 48, respectively. Alignment films 57, 59 are formed on surfaces of the transparent electrode films 56, 58, respectively. An absorption type polarizer P1 is attached to a surface on the front side of the glass substrate 46 on the front side. The absorption type polarizer P1 is configured and a polarization axis (polarization direction) thereof is disposed so that the absorption type polarizer P1 transmits horizontally-polarized light and absorbs vertically-polarized light. A reflection type polarizer P2 is attached to a surface on the back side of the glass substrate 48 on the back side. The reflection type polarizer P2 is configured and a polarization axis thereof is disposed so that the reflection type polarizer P2 transmits horizontally-polarized light and reflects vertically-polarized light. For the reflection type polarizer P2, for example, a DBEF (R) manufactured by 3M Company can be used.

On the other hand, the display device 28 is formed by a color monitor LCD. In other words, the display device 28 includes a color liquid-crystal panel 60 and a backlight 62 disposed on the back side of the color liquid-crystal panel 60. The color liquid-crystal panel 60 has a structure in which a void 70 is formed by making two glass substrates 64, 66 face each other with spacers 68 interposed therebetween. IPS liquid crystal 72 is encapsulated in the void 70. An entire outer periphery of the void 70 is sealed by a seal material 74. An absorption type polarizer P3 is attached to a surface on the front side of the front side glass substrate 64 (color filter substrate). The absorption type polarizer P3 is configured and a polarization axis thereof is disposed so that the absorption type polarizer P3 transmits horizontally-polarized light and absorbs vertically-polarized light. A color filter 76 and an alignment film 80 are sequentially stacked on a surface on the back side (surface facing the glass substrate 66) of the glass substrate 64. An array film 82 including a TFT circuit and an ITO transparent electrode film (pixel electrode), and an alignment film 84 are sequentially stacked on a surface on the front side (surface facing the glass substrate 64) of the front side glass substrate 66 (array substrate). An absorption type polarizer P4 is attached to a surface on the back side of the glass substrate 66. The absorption type polarizer P4 is configured and a polarization axis thereof is disposed so that the absorption type polarizer P4 absorbs horizontally-polarized light and transmits vertically-polarized light. The following table summarizes the relation of transmission, absorption and reflection of polarized plates P1 to P4 to horizontally-polarized light and vertically-polarized light.

| | P1 | P2 | P3 | P4 |
|---|---|---|---|---|
| | (absorption | (reflection | (absorption | (absorption |
| | type) | type) | type) | type) |
| Horizontally- | Transmit | Transmit | Transmit | Absorb |
| polarized light | | | | |
| Vertically- | Absorb | Reflect | Absorb | Transmit |
| polarized light | | | | |

An operation mode of the monitor inner mirror body 14 having the structure in FIG. 1 is switchable between a mirror state (high-reflectivity and non-antiglare state/low-reflectivity and antiglare state) and a monitor image display state. Each of the operation modes will be described.

### <<Mirror State (High-Reflectivity and Non-Antiglare State)>>

The liquid-crystal shutter 26 is set to be off (no voltage is applied to the liquid crystal 54) and the display device 28 is set to be off (no voltage is applied to liquid crystal 72 and the backlight 62 is off). At this time, outside light entering the liquid-crystal shutter 26 enters the absorption type polarizer P1. Horizontally-polarized light components of the entering outside light penetrate through the absorption type polarizer P1. A polarization axis of the penetrating horizontally-polarized light is rotated 90 degrees by the liquid crystal 54 and the horizontally-polarized light turns into vertically-polarized light. The vertically-polarized light is reflected by the reflection type polarizer P2 whose polarization axis is set to be horizontal. The polarization axis of the reflected vertically-polarized light is rotated 90 degrees by the liquid crystal 54 and the vertically-polarized light turns into horizontally-polarized light. The horizontally-polarized light penetrates through the absorption type polarizer P1 whose polarization axis is set to be horizontal, and is guided to the viewing point 45 of the viewer. Consequently, a high-reflectivity mirror state is obtained.

### <<Mirror State (Low-Reflectivity and Antiglare State)>>

An intermediate voltage between an off-state voltage and an on-state voltage (voltage that provides a state in which liquid-crystal molecules in the liquid crystal 54 are not completely activated) is applied to the liquid-crystal shutter 26 and the display device 28 is set to be off (no voltage is applied to the liquid crystal 72 and the backlight 62 is off). At this time, outside light entering the liquid-crystal shutter 26 enters the absorption type polarizer P1. Horizontally-polarized light components of the entering outside light penetrate through the absorption type polarizer P1. The penetrating horizontally-polarized light enters the liquid crystal 54, but since the intermediate voltage is applied to the liquid crystal 54, the entering horizontally-polarized light does not completely turn into vertically-polarized light and a part of the polarized light penetrates through the reflection type polarizer P2 and a part of the remaining polarized light is reflected by the reflection type polarizer P2. The reflected polarized light penetrates through the liquid crystal 54 and a part of the polarized light penetrates through the absorption type polarizer P1 and is guided to the viewing point 45 of the viewer. Consequently, a low-reflectivity and antiglare mirror state is obtained. The reflectivity can successively be changed by changing a voltage value of the intermediate voltage.

### <<Monitor Image Display State>>

The liquid-crystal shutter 26 is set to be on (voltage that provides a state in which liquid-crystal molecules in the liquid crystal 54 are completely activated is applied) and the display device 28 is set to be on (voltage according to each of pixels of an image is applied to each of pixels of the liquid crystal 72 and the backlight 62 is on). At this time, image light that is horizontally-polarized light is emitted from the absorption type polarizer P3 on an outermost surface of the display device 28. The image light penetrates through the liquid-crystal shutter 26 as it is and is guided to the viewing point 45 of the viewer and viewed by the viewer. At this time, outside light entering the liquid-crystal shutter 26 enters the absorption type polarizer P1. Vertically-polarized light of the entering outside light is absorbed by the absorption type polarizer P1. Also, horizontally-polarized light of the outside light penetrates through the liquid-crystal shutter 26, enters the display device 28, and is absorbed by the absorption type polarizer P4 or penetrates through the absorption type polarizer P4. Therefore, almost no horizontally-polarized light returns to the viewing point 45 of the viewer.

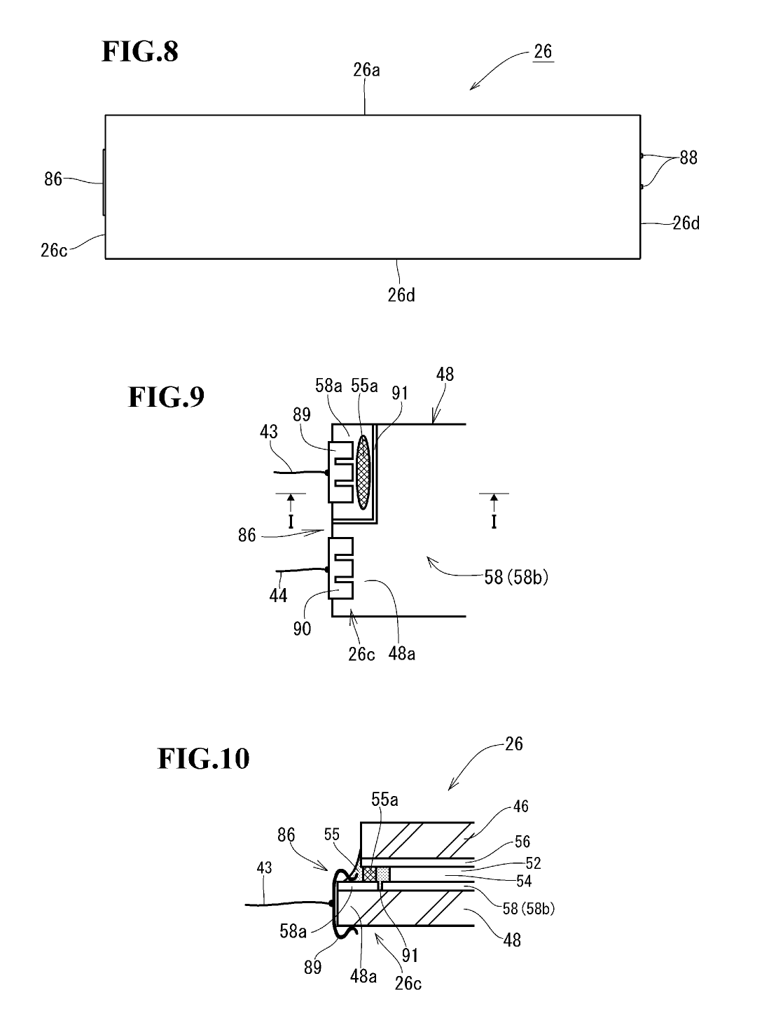

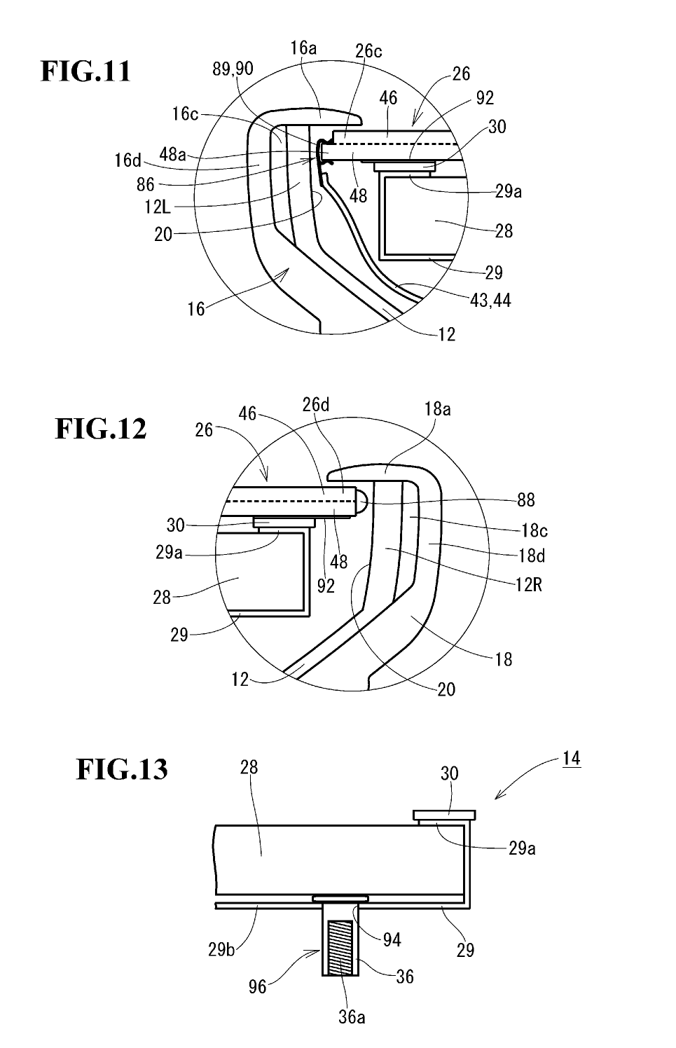

FIG. 8 illustrates a front structure of the liquid-crystal shutter 26. An entire front shape of the liquid-crystal shutter 26 is a horizontally-long quadrangular shape (horizontally-long rectangular shape). In other words, as the liquid-crystal shutter 26 is viewed from the front, an upper side 26a and a lower side 26b of the liquid-crystal shutter 26 form respective long sides that extend horizontally, and a left side 26c and a right side 26d of the liquid-crystal shutter 26 form respective short sides that extend vertically. An edge on the front side of each of the sides 26a, 26b, 26c, 26d can be chamfered to form a C-chamfered surface (that is, a cut having a surface inclined at an angle of, e.g., 45 degrees) or a R-chamfered surface (that is, a round cut). In particular, the long sides 26a, 26b are exposed at the front and viewed, and thus, chamfering the edges on the front side of the long side 26a, 26b enhances the design. A power supply section 86 is disposed at the left side 26c. Liquid-crystal encapsulation sections 88 are disposed at the right side 26d. The power supply section 86 forms a terminal that supplies a drive voltage to the liquid-crystal shutter 26. The power supply section 86 includes, e.g., later-described clip electrodes 89, 90. The liquid-crystal encapsulation sections 88 are each configured so as to have a structure in which an injection port for injecting the liquid crystal 54 to the void 52 (FIG. 7) of the liquid-crystal shutter 26 is closed by a seal material (adhesive). The injection port is formed in a part of an entire periphery of the seal material 55 in FIG. 7. A part of the seal material of each liquid-crystal encapsulation section 88 projects outward from end surfaces of the right sides 26d of the glass substrates 46, 48 and is solidified. The two glass substrates 46, 48 (FIG. 7) of the liquid-crystal shutter 26 are configured to be equal to each other in vertical dimension and different slightly (for example, around 2 mm) from each other in horizontal dimension. From among respective four sides of outer peripheries of the glass substrates 46, 48, the respective upper sides 26a, the respective lower sides 26b and the respective right sides 26d are disposed at respective same positions (mutually overlapped positions). Also, the left sides 26c are disposed at positions shifted from each other by an amount of the difference in horizontal dimension between the glass substrates 46, 48 (see FIGS. 10 and 11). At the left sides 26c of the glass substrates 46, 48, a left side projection 48a (FIGS. 10 and 11) that projects because of the shift is formed in the glass substrate 48. Two clip electrodes 89, 90 (FIGS. 9, 10 and 11) are mounted to the left side projection 48a in such a manner that the clip electrodes 89, 90 are arranged side by side along the left side 26c and clamp the left side projection 48a in a thickness direction of the glass substrate 48. The harnesses 43, 44 are soldered to respective bases of the clip electrodes 89, 90. The two clip electrodes 89, 90 are electrically connected to the transparent electrode films 56, 58 (FIGS. 7 and 10), respectively. The clip electrodes 89, 90 apply a drive voltage supplied from the harnesses 43, 44 to between the transparent electrode films 56, 58.

An example of a power supply channel for supplying power from the clip electrodes 89, 90 to the transparent electrode films 56, 58 will be described. FIG. 9 illustrates the left side 26c of the liquid-crystal shutter 26 with the glass substrate 46 removed. A dividing line 91 obtained by, e.g., laser cutting is formed on a left side of the transparent electrode film 58 formed on the surface of the glass substrate 48. The dividing line 91 separates a partial region 58a that is a part of the left side of the transparent electrode film 58 from another region 58b of the transparent electrode film 58. The region 58b is a region for applying a voltage to the liquid crystal 54. The partial region 58a and the other region 58b of the transparent electrode film 58 are electrically disconnected to each other by the dividing line 91. One clip electrode 89 is made to clamp the glass substrate 48 at the partial region 58a. The other clip electrode 90 is made to clamp the glass substrate 48 at the other region 58b. Consequently, the clip electrode 89 is electrically connected to the partial region 58a and the clip electrode 90 is electrically connected to the other region 58b. The harness 43 is connected to the clip electrode 89 and the harness 44 is connected to the clip electrode 90. A part of the entire seal material 55 sealing an outer periphery of the void 52 (FIG. 7, FIG. 10), the part being disposed in the partial region 58a, is formed of a conductive seal material 55a. A part other than the conductive seal material 55a of the seal material 55 is formed of a non-conductive seal material. FIG. 10 is an arrow I-I sectional view of FIG. 9. FIG. 10 illustrates the glass substrates 46, 48 held together by the seal material 55 (including the conductive seal material 55a). According to FIG. 10, the partial region 58a is electrically connected to the transparent electrode film 56 on the glass substrate 46 side via the conductive seal material 55a. Consequently, the harness 43 is electrically connected to the transparent electrode film 56 via the clip electrode 89, the partial region 58a and the conductive seal material 55a. Also, the harness 44 is electrically connected to the transparent conductive film 58 (other region 58b) via the clip electrode 90. Therefore, a voltage is applied to the liquid crystal 54 by applying a voltage to between the harnesses 43, 44.

As illustrated in FIG. 1, the entire left side 26c of the liquid-crystal shutter 26 is covered by a bezel 16a of the cover 16 and thus hidden from the viewing point 45 of the viewer. Consequently, the left side projection 48a of the glass substrate 48 and the clip electrodes 89, 90 are hidden by the bezel 16a. Likewise, the entire right side 26d of the liquid-crystal shutter 26 is covered by the bezel 18a of the cover 18 and thus hidden from the viewing point 45 of the viewer. Consequently, the liquid-crystal encapsulation sections 88 are hidden by the bezel 18a. On the other hand, no fittings are provided to end faces of the upper sides 26a and the lower sides 26b of the glass substrate 46, 48 and the linear end faces are thus exposed as they are to the outside world (see FIG. 6). As illustrated in FIG. 2A, there is only a narrow (thin) edging 20a that defines an upper side of the front recess 20 of the body 12 (that is, there is no part that covers the upper side 26a of the liquid-crystal shutter 26) above the upper side 26a of the liquid-crystal shutter 26. Also, there is only a narrow (thin) edging 20b that defines a lower side of the front recess 20 of the body 12 (that is, there is no part that covers the lower side 26b of the liquid-crystal shutter 26) below the lower side 26b of the liquid-crystal shutter 26 except the bulge 27 in which the optical sensor 24 and the LED 25 are installed. Consequently, the monitor inner mirror 10 has a smart design in its entirety as viewed from the front side. The left and right bezels 16a, 18a are put on the left side 26c and the right side 26d of the liquid-crystal shutter 26, providing an effect of preventing the liquid-crystal shutter 26 from coming off from the monitor inner mirror 10 by any chance.

FIG. 11 is an enlarged view of part A in FIG. 1 with the power supply section 86 as a center. The clip electrodes 89, 90 are attached to the left side projection 48a of the glass substrate 48 on the back side of the liquid-crystal shutter 26. A dark mask tape 92 of a dark color such as a black is attached to an entire periphery of a back of the glass substrate 48. The double-sided tape 30 is attached over the dark mask tape 92. The double-sided tape 30 holds the liquid-crystal shutter 26 and the display device 28 together. The dark mask tape 92 is formed to be wider than the double-sided tape 30. The double-sided tape 30 is disposed within a surface of the dark mask tape 92. Consequently, an entire periphery of the double-sided tape 30 is hidden from the viewing point 45 (FIG. 1) of the viewer by the dark mask tape 92. An outer peripheral end of the dark mask tape 92 is disposed so as to reach a position at which the outer peripheral end overlaps an inner peripheral end of the bezel 16a of the cover 16. The entire left side 26c of the liquid-crystal shutter is hidden from the viewing point 45 of the viewer by the bezel 16a of the cover 16. Consequently, the left side projection 48a of the glass substrate 48 and the clip electrodes 89, 90 are hidden by the bezel 16a.

FIG. 12 is an enlarged view of part B in FIG. 1 with a liquid-crystal encapsulation section 88 as a center. An outer peripheral end of the dark mask tape 92 is disposed so as to reach a position at which the outer peripheral end overlaps an inner peripheral end of the bezel 18a of the cover 18. The entire right side 26d of the liquid-crystal shutter is hidden from the viewing point 45 of the viewer by the bezel 18a of the cover 18. Consequently, the liquid-crystal encapsulation sections 88 are hidden by the bezel 18a.

An installation structure of bosses 36 for mounting the monitor inner mirror body 14 to the body 12 will be described. FIG. 13 is a schematic sectional view of the monitor inner mirror body 14 at a position indicated by arrows Z-Z in FIG. 1. A plate surface 29b is formed at a back of the back cover 29 made of a metal. A hole 94 is provided at each of four positions at which the respective bosses 36 are formed in the plate surface 29b. Blind nuts 96 (female-threaded rivets) are inserted to the respective holes 94 from the inner peripheral surface side of the back cover 29. A female thread 36a is formed in each blind nut 96. A part of a shaft of each blind nut 96 is crushed in an axis direction by a tool. Consequently, the blind nuts 96 are fixed to the back cover 29 so as to be unmovable in the axis direction of the blind nuts 96 and a direction around the respective axes of the blind nuts 96. The shafts of the blind nuts 96 project from the back cover 29 and form the respective bosses 36. The monitor inner mirror body 14 and the circuit board 40 are mounted to the body 12 by inserting the screws 42 (FIG. 1) to the respective female threads 36a.

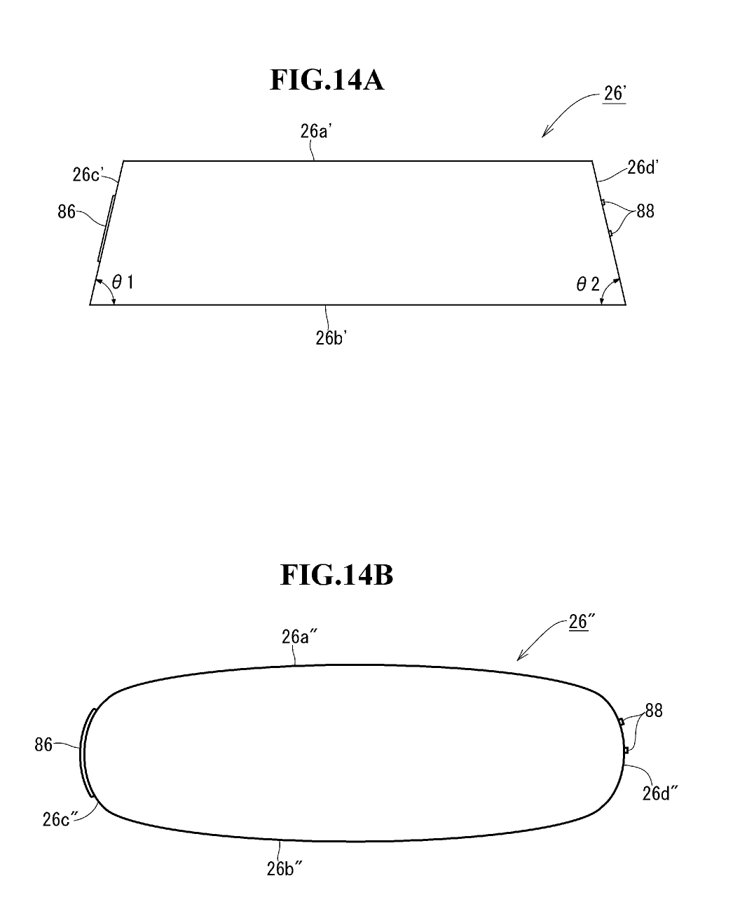

Although in the above-described embodiment, the front shape of the liquid-crystal shutter 26 is a horizontally-long rectangular shape, the front shape of the liquid-crystal shutter 26 is not limited to such shape. FIG. 14 illustrates another example of the front shape of the liquid-crystal shutter 26. The liquid-crystal shutter 26′ in FIG. 14A has a horizontally-long trapezoidal front shape. With respect to lengths of upper and lower long sides 26a′, 26b′, the lower side 26b′ is longer than the upper side 26a′. Left and right short sides 26c′ (left side), 26d′ (right sides) are equal in length. Therefore, left and right base angles θ1, θ2 are equal to each other. Also, the left and right short sides 26c′, 26d′ can be made to be different from each other in length (that is, the left and right base angles θ1, θ2 can be made to be different from each other). Of the left and right short sides 26c′, 26d′, the power supply section 86 is disposed at one short side 26c′ and the liquid-crystal encapsulation sections 88 are disposed at the other short side 26d′. The liquid-crystal shutter 26″ in FIG. 14B has a horizontally-long oval front shape. Upper and lower long sides 26a″ (upper side), 26b″ (lower side) and left and right short sides 26c″ (left side), 26d″ (right side) each have a curvature. Of the left and right short sides 26c″, 26d″, a power supply section 86 is disposed at one short side 26c″ and a liquid-crystal encapsulation sections 88 are disposed at the other short side 26d″.

Although in the above-described embodiment, the bezels 16a, 18a of the left and right covers 16, 18 are disposed off (floated) from a surface of the liquid-crystal shutter 26 (see FIGS. 1, 11 and 12), the bezels 16a, 18a can be disposed so as to abut on and be pressed against the surface of the liquid-crystal shutter 26. Although in the above-described embodiment, the covers 16, 18 have a left and right two-split configuration, the covers 16, 18 can be formed so as to have a left and right integrated configuration (that is, a configuration in which the retainer plates 16b, 18b are connected) and be attached to the body 12. Although in the above-described embodiment, the display device is formed of a liquid-crystal display device, the display device is not limited to such display device. In other words, the display device can be formed of, e.g., an organic EL display device. Although in the above-described embodiment, the front shape of the monitor inner mirror 10 is bilaterally symmetrical with respect to the central axis in a lateral direction, the front shape of the monitor inner mirror 10 is not limited to such shape. In other words, the front shape of the monitor inner mirror 10 can be bilaterally asymmetrical. Also, the monitor inner mirror 10 indicated in the above-described embodiment has a structure that can be assembled according to the following procedure.
(i) Put and dispose the horizontally-long monitor inner mirror body 14 in the front recess of the horizontally-long body 12;
(ii) Mount the monitor inner mirror body 14 to the body 12 by, e.g., screw-fastening the monitor inner mirror body 14 to the body 12 on the back side of the monitor inner mirror body 14 as necessary; and
(iii) Assemble the monitor inner mirror 10 by attaching the covers 16, 18 (the covers 16, 18 may be integrated) to the left and right side parts 12L, 12R of the body 12 so as to cover the left and right short sides of the monitor inner mirror body 14.

Such assembly structure can be applied to various other inner mirrors, for example, as follows:
A monitor inner mirror including a monitor inner mirror body using a half mirror instead of a liquid-crystal shutter; and
An inner mirror including an inner mirror body with no monitor equipped (for example, an electrochromic antiglare inner mirror body or an inner mirror body formed of a single ordinary mirror plate)

In particular, as with the liquid-crystal shutter, the electrochromic antiglare inner mirror body includes a power supply section and a liquid-crystal encapsulation section and thus such structure can suitably be applied to the electrochromic antiglare inner mirror body. In this case, the power supply section and the liquid-crystal encapsulation section of the electrochromic element are disposed so as to be separated to left and right short sides, allowing designing widths of covers for the left and right short sides to be equal to each other and thus allowing a good design. Also, although the above embodiment has been described in terms of the case where IPS liquid crystal is used as the display device 28, a display device of another operation mode such as TN liquid crystal or VA liquid crystal may be used.

### REFERENCE SIGNS LIST

10 . . . monitor inner mirror, 12 . . . body, 12L . . . left side part of body, 12R . . . right side part of body, 14 . . . monitor inner mirror body, 16, 18 . . . cover, 26 . . . liquid-crystal shutter, 26a, 26b . . . upper and lower long sides of liquid-crystal shutter, 26c, 26d . . . left and right short sides of liquid-crystal shutter, 28 . . . display device, 42 . . . screw, 86 . . . power supply section, 88 . . . liquid-crystal encapsulation section

1. A monitor inner mirror for a vehicle, comprising a liquid-crystal shutter that is formed by disposing a reflection type polarizer on a back of a liquid-crystal cell and can be switched between a mirror state and a transmissive state by electrical driving and a display device disposed behind the liquid-crystal shutter, an entire front shape of the monitor inner mirror being a horizontally-long shape,
wherein a power supply section that supplies a drive voltage to the liquid-crystal shutter is disposed at one short side of left and right short sides of the liquid-crystal shutter and a liquid-crystal encapsulation section including an injection port used for injecting liquid crystal to the liquid-crystal shutter, the injection port being sealed by a seal material, is disposed at another short side of the left and right short sides.

2. The monitor inner mirror for a vehicle according to claim 1, comprising;
a body with the liquid-crystal shutter and the display device disposed at a front thereof; and
a cover that visually covers the power supply section and the liquid-crystal encapsulation section of the liquid-crystal shutter as viewed from the front of the body, the cover being attached to the body.

3. The monitor inner mirror for a vehicle for a vehicle according to claim 2, wherein the cover is separated to a left part and a right part that are attached to left and right side parts of the body, respectively.

4. The monitor inner mirror for a vehicle according to claim 2, wherein upper and lower long sides of the liquid-crystal shutter are exposed at the front of the body.

5. The monitor inner mirror for a vehicle according to claim 2, wherein:
the liquid-crystal shutter is mounted to a front of the display device; and
the display device is mounted to the body by fastening a back of the display device to the body via a screw.

6. The monitor inner minor for a vehicle according to claim 5, wherein the cover visually covers a head of the screw on a rear side of the body.

7. The monitor inner mirror for a vehicle according to claim 2, wherein the cover clamps left and right side parts of the body from the front side and the rear side of the body and is thereby attached to the left and right side parts of the body.

8. The monitor inner mirror for a vehicle according to claim 3, wherein upper and lower long sides of the liquid-crystal shutter are exposed at the front of the body.

9. The monitor inner mirror for a vehicle according to claim 3, wherein;
the liquid-crystal shutter is mounted to a front of the display device; and
the display device is mounted to the body by fastening a back of the display device to the body via a screw.

10. The monitor inner mirror for a vehicle according to claim 9, wherein the cover visually covers a head of the screw on a rear side of the body.

11. The monitor inner mirror for a vehicle according to claim 3, wherein the cover clamps left and right side parts of the body from the front side and the rear side of the body and is thereby attached to the left and right side parts of the body.
